(19) United States
(12) Patent Application Publication
(10) Pub. No.: US 2013/0299328 A1
(43) Pub. Date: Nov. 14, 2013

(54) MICRO ELECTRO MECHANICAL SYSTEM (MEMS) MICROWAVE SWITCH STRUCTURES

(71) Applicants: Andrew Malczewski, Richardson, TX (US); Cody B. Moody, Frisco, TX (US); Brandon W. Pillans, Plano, TX (US)

(72) Inventors: Andrew Malczewski, Richardson, TX (US); Cody B. Moody, Frisco, TX (US); Brandon W. Pillans, Plano, TX (US)

(73) Assignee: Raytheon Company, Waltham, MA (US)

(21) Appl. No.: 13/470,573

(22) Filed: May 14, 2012

(51) Int. Cl. H01H 9/00; H02M 3/06

(52) U.S. Cl. 200/5 R; 307/109

(57) ABSTRACT

A structure having a plurality serially coupled variable capacitors, each one of the variable capacitors having a pair of plates, one of the plates being electrostatically moveable relative to the other one of the plates, to provide each one of the variable capacitors with a variable capacitance; and a transmission line. A first one of the variable capacitors has a first one of the one plates thereof coupled between and input and output of the transmission line and a second one of the plates thereof serially coupled to a first one of the plates of a second one of the variable capacitors.

### TECHNICAL FIELD

This disclosure relates generally to Micro Electro Mechanical System (MEMS) microwave switch structures and more particularly to high power MEMS microwave switch structures.

### BACKGROUND AND SUMMARY

As is known in the art, there is a need to improve power handling of loss low tunable small size MMIC designs for emerging applications. One technique uses capacitive RF MEMS digital switch designs. One such MEMS switch is described in U.S. Pat. No. 6,791,441, issued Sep. 14, 2004, entitled “Micro-electro-mechanical switch, and methods of making and using it”, inventors Brandon W. Pillans et al., and is shown diagrammatically in FIGS. 1A-1C and schematically in FIG. 1D to include resilient flexible, electrically conductive member 1 supported by a pair of electrically conductive posts 2 above a lower conductive member 3 having a dielectric layer 4 thereon, as shown. A portion of a strip conductor 5 of a microwave transmission line 5A (such as a microstrip or coplanar wave guide transmission line, here coplanar waveguide) disposed between the input and output of the transmission line 5A provides the lower conductive member 3 of the MEMS switch. In the absence of a dc voltage being applied across the members 1 and 3, the MEMs switch appears as a capacitor having a relatively low capacitance (FIG. 1A) and radio frequency (RF) energy fed to the input of the transmission line passes substantially unimpeded to the output. On the other hand, when a relatively large dc voltage is applied between the electrode 1 and 3 (FIG. 1C), electrostatic forces on the members 1 and 3 pulls the upper, resilient flexible, electrically conductive member 1 downwards toward the lower member 3 thereby configuring the switch as a capacitor having a relatively large capacitance resulting in a large amount of the input RF energy to be diverted from the output to the upper electrode (in MEMS industry, top electrode is commonly referred to as a “beam” or “membrane”) 1 and then to the pair of electrically conductive posts to the microwave transmission line 5A ground plane. Thus, the members 1 and 3 provide upper and lower electrode or plates of the capacitor.

As is also known in the art, there is a need for MEMS switch designs that are relatively small and yet are required to handle large RF power levels. More particularly, the inventors have recognized that when operating with high RF voltages, these high RF voltages may have the undesirable effect of producing electrostatic forces on the electrodes 1 and 3 when in the low capacitance condition thereby biasing the switching to the high capacitance condition.

In accordance with the present disclosure, a structure is provided having: a plurality serially coupled variable capacitors, each one of the variable capacitors having a pair of plates, one of the plates being electrostatically moveable relative to the other one of the plates, to provide each one of the variable capacitors with a variable capacitance; and a transmission line. A first one of the variable capacitors has a first one of the one plates thereof coupled between an input and output of the transmission line and a second one of the plates thereof serially coupled to a first one of the plates of a second one of the variable capacitors.

In one embodiment, the transmission line is a microwave transmission line having a strip conductor and a ground plane conductor spaced from the strip conductor; and wherein the first one of the plates of the first one of the variable capacitors includes a portion of the strip conductor disposed between the input and the output.

In one embodiment, a voltage between the first one of the plates of the first one of the variable capacitors and a second one of the plates of the second one of the variable capacitors comprises a sum of a voltage between the pair of plates of the first one of the variable capacitors and a voltage across the pair of the plates of the second one of the variable capacitors.

In one embodiment, the portion of the strip conductor disposed between the input and the output of the transmission line comprises an inner region of the first one of the plates of the first one of the variable capacitors.

In one embodiment, an outer region of the second one of the plates of the first one of the variable capacitors is connected to the first plate of the second one of the variable capacitors.

In one embodiment, the second one of the plates of the first one of the variable capacitors comprises a resilient, flexible electrically conductive member supported above, the first one of the plates of the first one of the variable capacitors.

In one embodiment, an inner region of the resilient, flexible electrically conductive member is supported above the first plate of the first one of the variable capacitors and wherein one outer end of the resilient, flexible electrically conductive member is electrically connected to the first plate of the second one of the variable capacitors.

In one embodiment, one of the pair of electrodes of the second one of the variable capacitors comprises a resilient, flexible electrically conductive member supported above the other one of the plates of the second one of the variable capacitors.

In one embodiment, the second plate of the second one of the variable capacitors is connected to the ground plane conductor.

With such an arrangement, a microwave MEMS switching structure is provided having increased the power handling and which allows much higher power handling in a more compact size than conventional MMIC circuits needed for emerging GaN based systems.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1A is a top view of a MEMS switch according to the PRIOR ART;

FIG. 1B is a cross sectional view of the MEMS switch of FIG. 1A taken along line 1B-1B of FIG. 1A according to the PRIOR ART;

FIG. 1C is a cross sectional view of the MEMS switch of FIG. 1A taken along line 1C-1C of FIG. 1A according to the PRIOR ART;

FIG. 1D is a schematic diagram of the MEMS switch of FIG. 1A according to the PRIOR ART

FIG. 2A is a schematic diagram of a MEMS switch according to the disclosure;

FIG. 2B is a top view of the MEMS switch of FIG. 2A according to the disclosure;

FIG. 2C is a cross sectional view of the MEMS switch of FIG. 2B, such cross section being taken allowing line 2C-2C of FIG. 2B;

FIG. 3A is a schematic diagram of a MEMS switch of FIG. 2A connected to a dc control circuit according to the disclosure;

FIG. 3B is a top view of the MEMS switch of FIG. 3A connected to a dc control circuit according to the disclosure;

FIG. 4A is a schematic diagram of a MEMS switch of according to another embodiment of the disclosure;

FIG. 4B is a top view of the MEMS switch of FIG. 4A according to the other embodiment of the disclosure;

FIG. 4C is a cross sectional view of the MEMS switch of FIG. 4B, such cross section being taken allowing line 4C-4C of FIG. 2B;

FIG. 5A is a schematic diagram of a MEMS switch of according to still another embodiment of the disclosure; and

FIG. 5B is a top view of the MEMS switch of FIG. 5A according to the other embodiment of the disclosure.

Like reference symbols in the various drawings indicate like elements.

### DETAILED DESCRIPTION

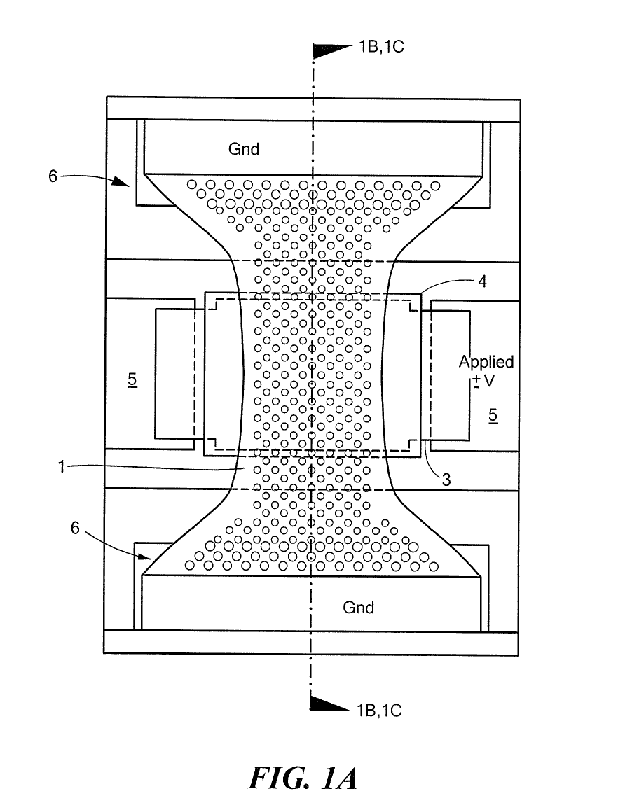

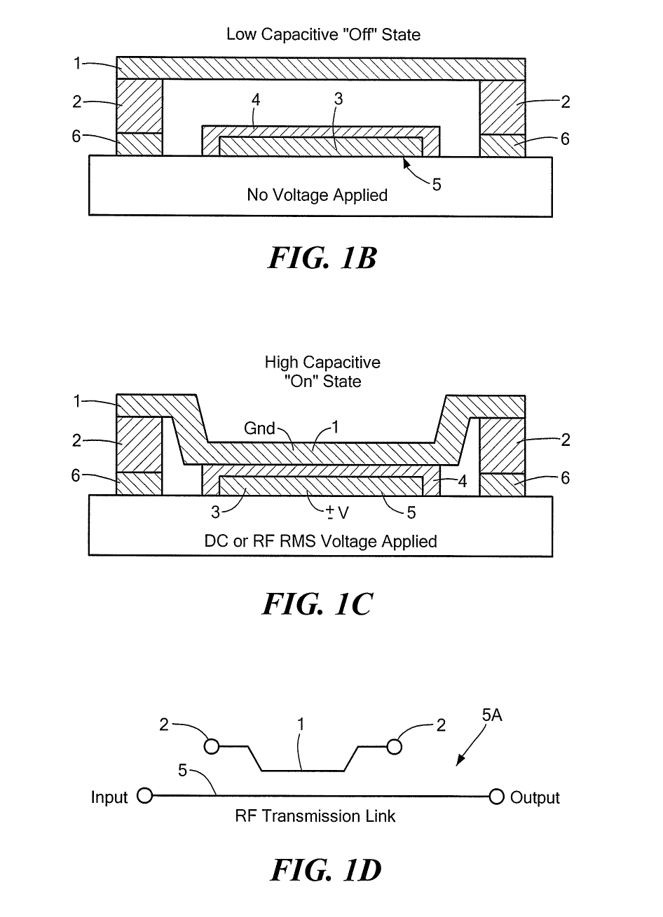

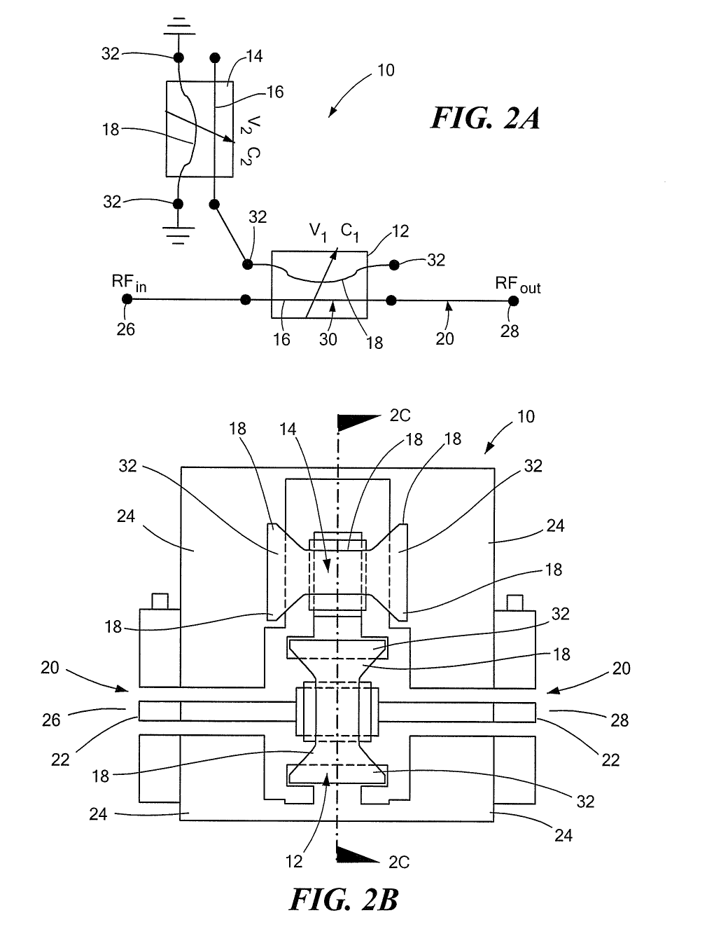

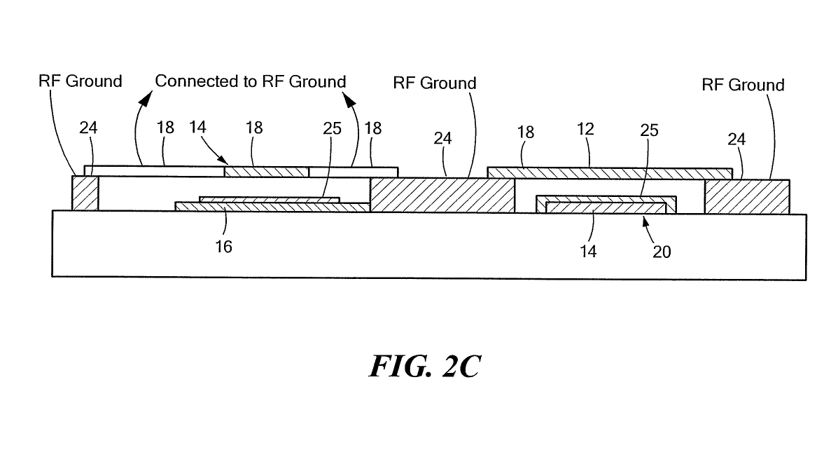

Referring now to FIGS. 2A, 2B, and 2C, a structure 10 is shown having: a plurality serially coupled variable capacitors 12, 14, each one of the variable capacitors 12, 14 having a pair of plates 16, 18, one of the plates, here plate 18, being electrostatically moveable relative to the other one of the plates, here plate 16, to provide each one of the variable capacitors 12, 14 with a variable capacitance; and a transmission line 20. Here, each one of the variable capacitors 12, 14 is a MEMS switch such as described in the above referenced U.S. Pat. No. 6,791,441. A first one of the variable capacitors 12 has a first one of the one plates 16 thereof coupled between input 22 and output 24 of the transmission line 20 and a second one of the plates 18 thereof serially coupled to a first one of the plates 18 of a second one of the variable capacitors 14, as shown. It is noted that the plates 16 are coated with a dielectric layer 25, as shown in FIG. 1B.

The second one of the plates 18 of the first and second variable capacitors 12, 14 comprises a resilient, flexible electrically conductive member supported above, the first one of the plates 16 of the first and second variable capacitors 12, 14, respectively, as shown in FIG. 2C.

Here, in this embodiment, the transmission line 20 is a microwave transmission line, here for example coplanar waveguide, having a strip conductor 22 and a ground plane conductor 24 spaced from the strip conductor 22. The first one of the plates 16 of the first one of the variable capacitors 12 includes a portion 30 of the strip conductor 22 disposed between an input 26 and the output 28 of the transmission line 20. More particularly, the portion 30 of the strip conductor 22 disposed between the input 24 and the output 26 of the transmission line 20 comprises an inner region of the first one of the plates 16 of the first one of the variable capacitors 12. An outer region 32, of the second one of the plates 18 of the first one of the variable capacitors 12 is connected to the first plate 16 of the second one of the variable capacitors 14, as shown in FIG. 2B. The second one of the plates 18 of the second one of the variable capacitors 14 is connected to the ground plane conductor 24 of the transmission line 20, as shown in FIG. 2B.

It is noted that an inner region of the resilient, flexible electrically conductive member 18 is supported above the first plate 16 of the first one of the variable capacitors 12 and one outer end of the resilient, flexible electrically conductive member 18 is electrically connected to the first plate 16 of the second one of the variable capacitors 14.

More particularly, each one of the resilient, flexible electrically conductive members 18 is supported at the ends 30 thereof by vertical, electrically conductive posts 24 electrically connected at the top or upper ends thereof to the ends 30 of the resilient, flexible electrically conductive members 18. The lower ends of the posts 24 are supported on, and electrically connected to, the ground plane conductor 24 of the transmission line 20.

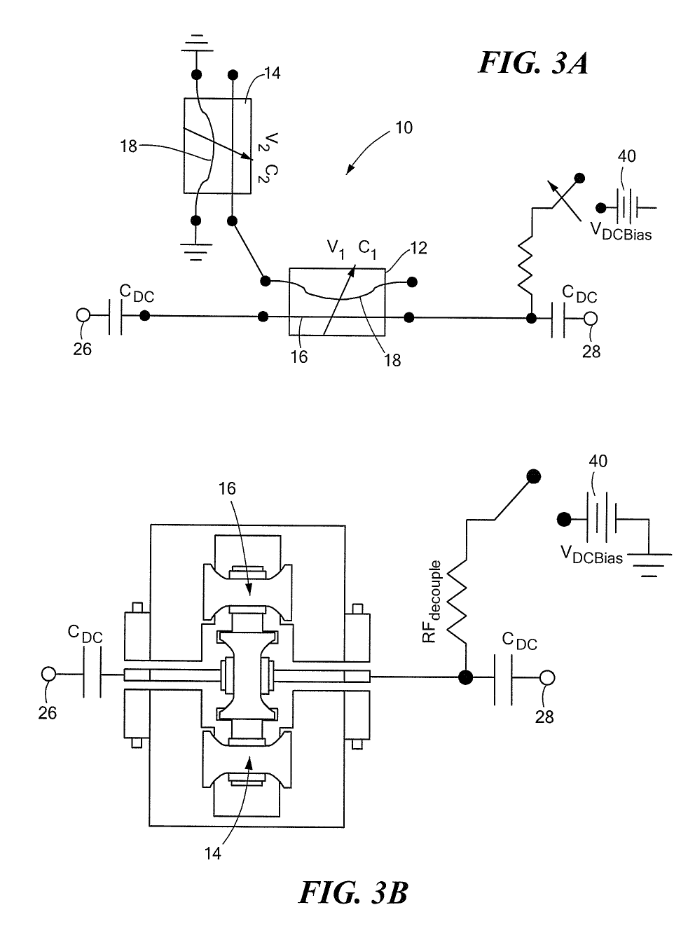

In operation, when the variable capacitors 14, 12 are placed in a relatively low capacitance or “off” condition by electrically de-coupling the first electrode 16 of the first variable capacitor 12 from a dc source 40 via a switch, as shown in FIGS. 3A and 3B, the resilient, flexible electrically conductive member 18 is suspended away from the plates 16 to enable input microwave energy fed to input 26 to pass substantially unimpeded to the output 28 of the transmission line 20. It is also noted that an RF voltage (V1+V2) between the first one of the plates 16 of the first one of the variable capacitors 12 and a second one of the plates 18 of the second one of the variable capacitors 14 comprises a sum of a voltage (V1) between the pair of plates 16, 18 of the first one of the variable capacitors 12 and a voltage (V2) across the pair of the plates 16, 18 of the second one of the variable capacitors 14, as indicated in FIG. 2A. It is noted that dc blocking capacitors C_{DC} are provided as shown. Thus, when Vrf on transmission line 20 sets-up, the voltage is split over the 2 devices 16,18 and thus power handling of the total system is much improved as each device only has to withstand half the total voltage).

On the other hand, when the first electrode 16 is electrically coupled to the dc source 40, the resilient, flexible electrically conductive member 18 flexed downward by electrostatic attractive forces towards the electrode 16 placing the variable capacitors 12, 14 in the high capacitance or “on” conditions. The RF energy at the input 26 is thus diverted to ground though the “on” variable capacitors 14, 16.

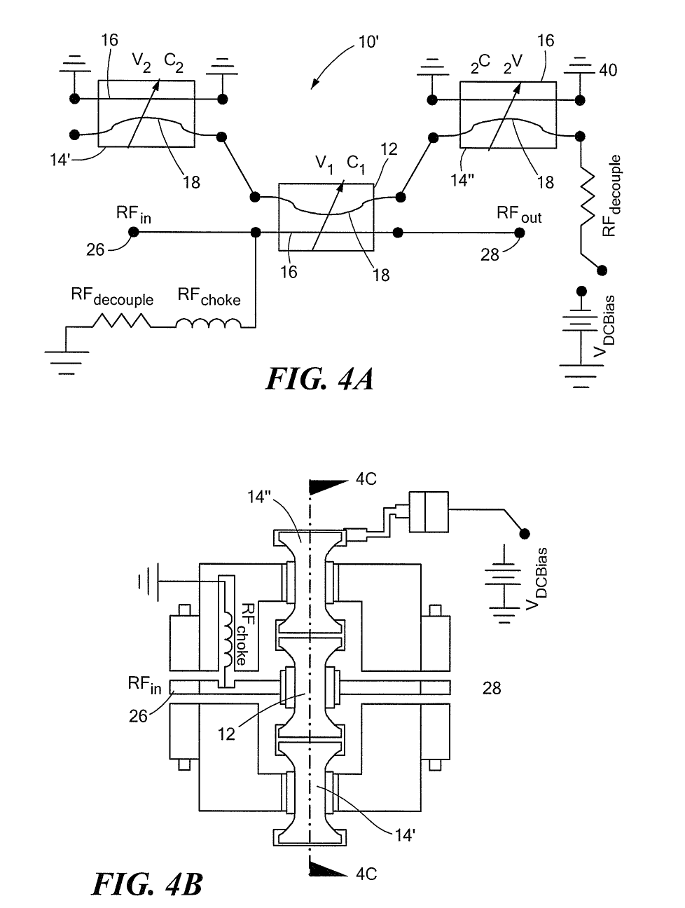

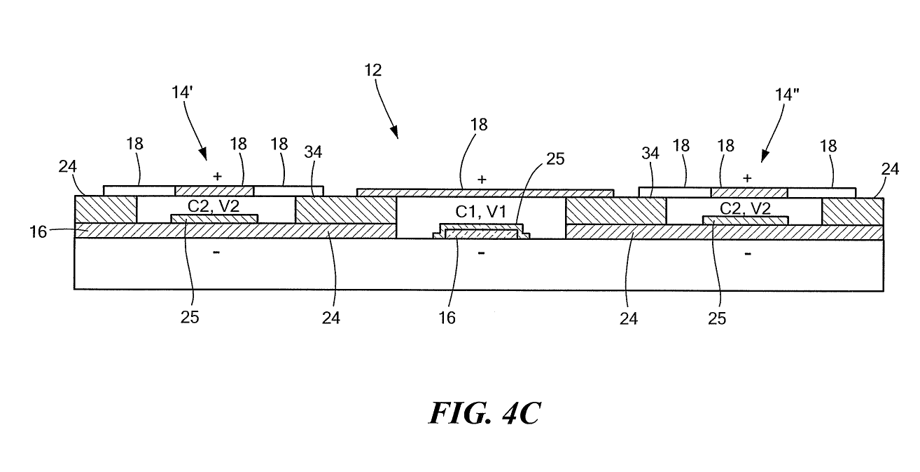

Referring now to FIGS. 4A and 4B, here each end of the resilient, flexible electrically conductive member 18 of the first variable capacitor 14 is coupled to the first electrode 16 of a pair of second variable capacitor 14′ and 14″, as shown. Thus, here, let it be assumed that all variable capacitors 14, 16′ and 16″ have the same capacitance. Whereas in the case where there are only two variable capacitors 14 and 16, as described above in connection with FIG. 2, there is an even voltage division between the two variable capacitors 14 and 16 and the effective on state capacitance would be halved. On the other hand, with three variable capacitors 12, 14′, 14″ as in FIGS. 4A and 4B, then ⅔ of the voltage is dropped across variable capacitors 14 (a 33% increase in terms of voltage handling, thus 77% power improvement assuming to first order V²/Zo relationship) and the “on” condition, the capacitance is reduced by only 33% instead of 50%. Therefore, one gains “on” condition capacitance at the expense of power handling. Having variable capacitors 12, 14′, 14″ also helps from another point of view; Power division needs to be equal across the switch or one side might go down and not the other (due to current distribution in the switch at higher RF frequencies). Thus this is a benefit to the design but not a necessity.

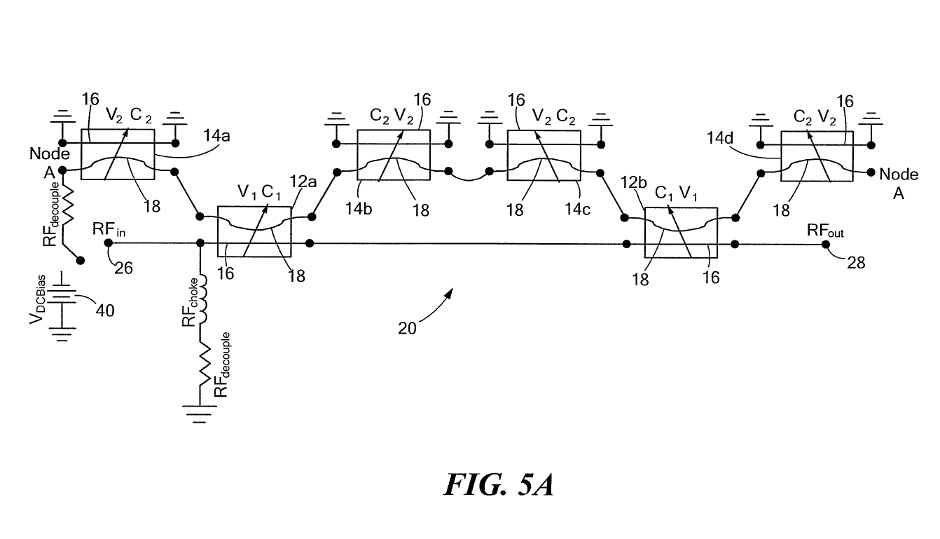

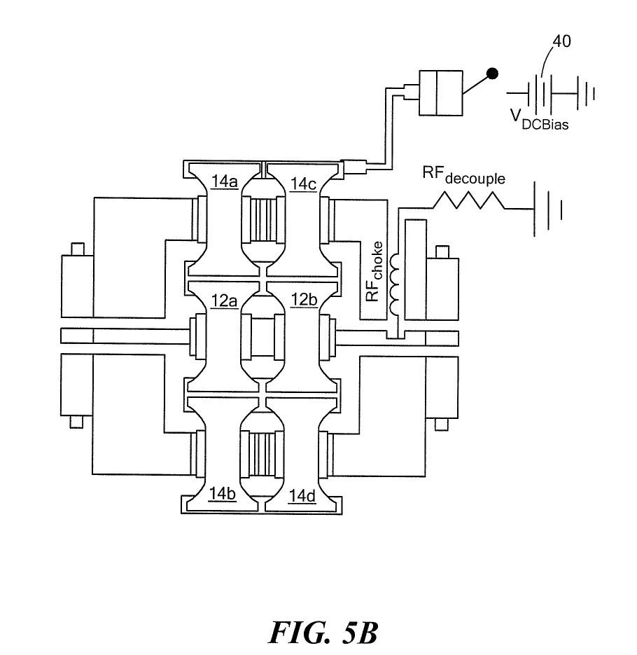

Referring now to FIGS. 5A and 5B, here there are two first variable capacitors 12a and 12b cascade connected along the transmission line 20. The ends of the resilient, flexible electrically conductive members 18 of the two first variable capacitors 12a and 12b are each connected to a pair of the second variable capacitors 14a, 14b and 14c, 14d, as shown. Here, it is noted that the flexible electrically conductive members 18 of the six variable capacitors 12a, 12b, 14a, 14b and 14c, 14d are serially connected, as shown.

It is noted that any number of variable capacitors in series to ground from the variable capacitors 14 may be used and any capacitance values may be used.

A number of embodiments of the disclosure have been described. Nevertheless, it will be understood that various modifications may be made without departing from the spirit and scope of the disclosure. Accordingly, other embodiments are within the scope of the following claims.

What is claimed is:

1. A structure comprising:
a plurality serially coupled variable capacitors, each one of the variable capacitors having a pair plates, one of the plates being electrostatically moveable relative to the other one of the plates, to provide each one of the variable capacitors with a variable capacitance;
a transmission line;
wherein a first one of the variable capacitors has a first one of the one plates thereof coupled between and input and output of the transmission line and a second one of the plates thereof serially coupled to a first one of the plates of a second one of the variable capacitors.

2. The structure recited in claim 1 wherein the transmission line is a microwave transmission line having a strip conductor and a ground plane conductor spaced from the strip conductor; and wherein the first one of the plates of the first one of the variable capacitors includes a portion of the strip conductor disposed between the input and the output.

3. The structure recited in claim 2 wherein a voltage between the first one of the plates of the first one of the variable capacitors and a second one of the plates of the second one of the variable capacitors comprises a sum of a voltage between the pair of plates of the first one of the variable capacitors and a voltage across the pair of the plates of the second one of the variable capacitors.

4. The structure recited in claim 3 wherein the portion of the strip conductor disposed between the input and the output of the transmission line comprises an inner region of the first one of the plates of the first one of the variable capacitors.

5. The structure recited in claim 4 wherein an outer region of the second one of the plates of the first one of the variable capacitors is connected to the first plate of the second one of the variable capacitors.

6. The structure recited in claim 5 wherein the second one of the plates of the first one of the variable capacitors comprises a resilient, flexible electrically conductive member supported above, the first one of the plates of the first one of the variable capacitors.

7. The structure recited in claim 6 wherein an inner region of the resilient, flexible electrically conductive member is supported above the first plate of the first one of the variable capacitors and wherein one outer end of the resilient, flexible electrically conductive member is electrically connected to the first plate of the second one of the variable capacitors.

8. The structure recited in claim 7 wherein one of the pair of electrodes of the second one of the variable capacitors comprises a resilient, flexible electrically conductive member supported above the other one of the plates of the second one of the variable capacitors.

9. The structure recited in claim 8 wherein the second plate of the second one of the variable capacitors is connected to the ground plane conductor.

10. The structure recited in claim 1 wherein a voltage between the first one of the plates of the first one of the variable capacitors and a second one of the plates of the second one of the variable capacitors comprises a sum of a voltage between the pair of plates of the first one of the variable capacitors and a voltage across the pair of the plates of the second one of the variable capacitors.

11. The structure recited in claim 10 wherein the portion of the strip conductor disposed between the input and the output of the transmission line comprises an inner region of the first one of the plates of the first one of the variable capacitors.

12. The structure recited in claim 11 wherein an outer region of the second one of the plates of the first one of the variable capacitors is connected to the first plate of the second one of the variable capacitors.

13. The structure recited in claim 12 wherein the second one of the plates of the first one of the variable capacitors comprises a resilient, flexible electrically conductive member supported above, the first one of the plates of the first one of the variable capacitors.

14. The structure recited in claim 13 wherein an inner region of the resilient, flexible member is supported above the first plate of the first one of the variable capacitors and wherein one outer end of the resilient, flexible electrically conductive member is electrically connected to the first plate of the second one of the variable capacitors.

15. The structure recited in claim 14 wherein one of the pair of electrodes of the second one of the variable capacitors comprises a resilient, flexible electrically conductive member supported above the other one of the plates of the second one of the variable capacitors.

16. A structure, comprising:
a plurality variable capacitors, each one of the variable capacitors having a pair of plates, one of the plates being electrostatically moveable with respect to the other one of the plates, to provide such one of the variable capacitors with a variable capacitance;
a transmission line having an input and an output;
wherein a first one of the variable capacitors is coupled between the input and the output; and
wherein, when the first one of the variable capacitors has the first capacitance, a portion of microwave energy fed to the input serially coupled to the first one of the variable capacitors and then from the first one of the variable capacitors is coupled serially to another one of the variable capacitors, and when the first one of the variable capacitors has a different capacitance, a different portion of microwave energy fed to the input is serially coupled to the first one of the variable capacitors and then from the first one of the variable capacitors is coupled in parallel to a plurality of other ones of the variable capacitors.

17. The structure recited in claim 16 wherein each one of the variable capacitors switch between two different capacitances.

18. A structure, comprising:
a plurality of switches, each one of the switches, comprising:
a first electrode;
second electrode comprising a resilient, flexible electrical conductive member;
a pair of electrically conductive posts;
wherein the resilient, flexible electrical conductive member is supported at, and electrically connected to, ends thereof by the electrically conductive posts, a portion of the flexible electrical conductive member disposed between the posts being disposed over the electrode; and
wherein one of the posts of one of the switches is coupled to the electrode of a different one of the plurality of switches.

19. The structure recited in claim 18 including a microwave transmission line having an input and an output, the microwave transmission line having a strip conductor and a ground plane conductor; and wherein the first electrode of a first one of the switches comprises a portion of the strip conductor between the input and the output.

20. A microwave switch, comprising:
a plurality of switching elements, each one of the switching elements comprising:
a variable capacitor having a pair of plates, one of the plates being electrostatically moveable with respect to the other one of the plates;
a microwave transmission line connected to a first one of the plates of a first one of the switching elements;
wherein an inner region of a second one of the plates of the first one of the switching elements is capacitively coupled to the first one of the plates thereof and an outer region of said second one of the plates is connected to first plate of a second one of the other switching elements;
wherein an inner region of the second plate of the second one of the switching elements is capacitively coupled to second plate of said second one of the switching elements.

21. A structure comprising:
a plurality variable capacitors, each one of the variable capacitors having a pair of plates electrostatically moveable with respect to each other to provide each one of the variable capacitors with a variable capacitance;
a transmission line;
wherein a first one of the variable capacitors is coupled between and input and output of the transmission line;
wherein when the capacitance of the first one of the variable capacitors is varied, varying portions of current fed to the input are diverted from the output to the first one of the variable capacitors and such current is then divided between a pair of first variable capacitors outputs with the current at one of the pair of first variable capacitors outputs being serially coupled to a second one of the variable capacitors and then to a second element output and when the capacitance of the second one of the variable capacitors is varied, varying portions of current serially coupled to the second element are passed to the second element output; and
wherein a voltage on the transmission line is divided among the plurality of variable capacitors.
